(19) United States
(12) Patent Application Publication
(10) Pub. No.: US 2014/0038648 A1
(43) Pub. Date: Feb. 6, 2014

(54) PROCESS AND SYSTEM FOR INSERTING CONTENT INTO SHORT MESSAGE SERVICE (SMS) MESSAGES AT THE DELIVERY END OF GLOBAL SYSTEM FOR MOBILE COMMUNICATION (GSM) NETWORKS

(71) Applicant: MURTY VLN ORUGANTI, HYDERABAD (IN)

(72) Inventor: MURTY VLN ORUGANTI, HYDERABAD (IN)

(21) Appl. No.: 13/563,799

(22) Filed: Aug. 1, 2012

(51) Int. Cl. H04W 4/14

(52) U.S. Cl. 455/466

(57) ABSTRACT

A system intended to intercept Mobile Terminated Short Message Service (MT SMS) at the mobile operator network before delivery, to provide text based mobile advertisement service. The system processes the MT SMS, selects for appropriate advertisement based on pre-configured advertisement selection rules and delivers the SMS along with the advertisement to the recipient mobile user. The system works on the protocols of Signaling System No. 7 (SS7) CAMEL Application Part (CAP) version 4 control triggers and Mobile Application Part (MAP) coupled with business logic to offer the service.

### BRIEF DESCRIPTION OF THE DRAWINGS

FIG. 1 presents a high-level flow diagram of Short Message Service (SMS) flow between Global System for Mobile Communication (GSM) carrier network elements, and the location of the system of the present invention within the network, according to an exemplary embodiment of the invention;

FIG. 2 presents a functional diagram of the functional entities (modules) of the system according to an exemplary embodiment of the invention; and

FIG. 3 presents a flow diagram of protocol level triggers between the operator switch Message Switching Center (MSC) and the system of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claim.

Broadly, an embodiment of the present invention generally provides a process and system for injecting text-based content into SMS messages at the delivery end of GSM networks, in which process the method is transparent to the Short Message Service Center (SMSC) using Intelligent Network Application Part (INAP) protocol. The process also includes triggering other systems to deliver/take an appropriate action before or after delivery of the SMS, based upon the keywords in the original message. The process also includes the content selection based on the location of the subscriber mobile device.

Content injection may be performed to the subscribed users only. Subscribed users may be gratified by direct benefits such as talk time, SMS credits, cash, or reward points which may be redeemed against gifts or donated to a trust for a noble cause. The gratification may be based on number of injections, number of interactions through Wireless Application Protocol (WAP) link, etcetera. The system may be used to cater local information for the in-roamers for every incoming SMS they receive, and may be integrated with the Welcome Roamer system so that auto provisioning may be performed using Mobile Markup Language (MML) commands at the Home Location Register (HLR) level.

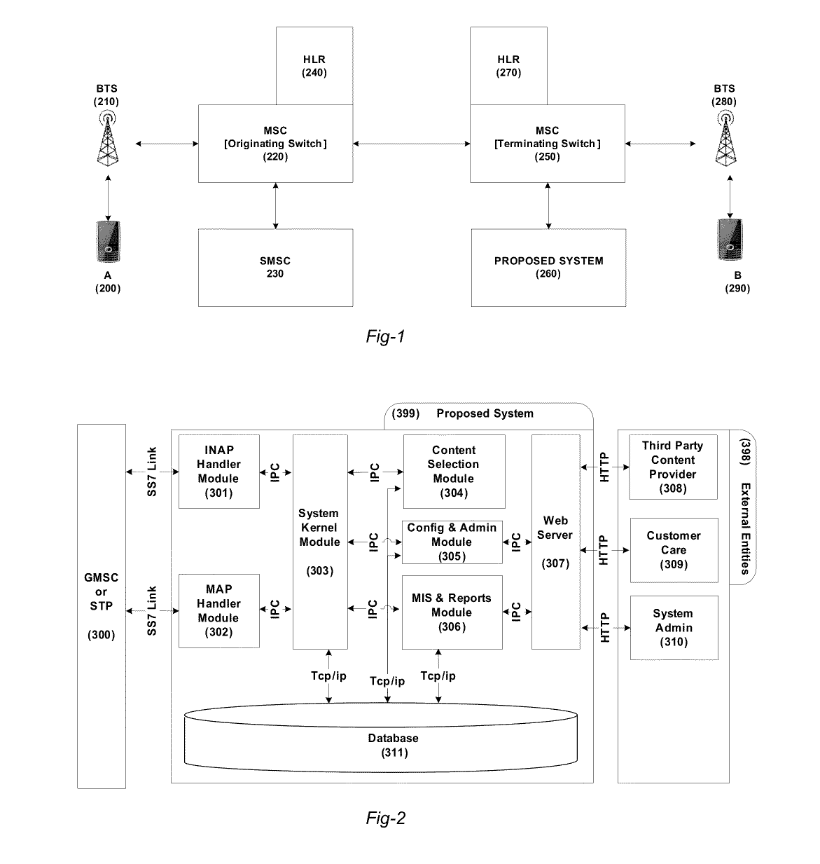

According to an exemplary embodiment of the invention, the process may comprise the following steps. Referring now to FIG. 1, an SMS may be sent by an Originating Mobile Subscriber (O-MS) 200, who may be latched on to the operator Base Transceiver Station (BTS) 210, may be received at an Origination Switch (O-MSC) 220 and forwarded to the operator SMSC 230 for delivery to a Recipient Mobile Subscriber (R-MS) 290. The SMSC 230 may enquire about the routing information [in this case, the Terminating Switch (T-MSC) 250] and send it to the T-MSC 250. Once the routing information is received by the SMSC 230, the SMSC 230 may forward the SMS to be delivered to the T-MSC 250. The T-MSC 250 may ask the proposed system 260, which may act as the Service Control Point SCP, for the next action to be taken. As decided by the proposed system 260, the T-MSC may forward the SMS to the proposed system 260 instead of delivering it to the MS 290. Once the SMS is received by the proposed system 260, it acts as a SMSC and will deliver the SMS (the original message plus content) to the R-MS 290. It is to be noted that, if the O-MS 200 and the R-MS 290 are subscribed to the same carrier, the O-MSC 220 and the T-MSC 250 may be the same entity.

Referring now to FIG. 2, the INAP Handler Module 301 may send and receive all of the INAP protocol messages related to the proposed system 399. The INAP Handler Module 301 may be used to encode and decode the required INAP messages in the specified format (vide specification numbers ETSI TS 129 078 v9.2.0 or 3GPP TS 29.078 version 9.2.0 Rel 9 for CAP 4 messages). The parsing of various parameters may be performed as per ANS.1 notation (vide specification numbers X.208, X.680 and X.690 of ASN.1). The INAP Handler Module 301 may store the Calling Party Number (CPN) and Destination Subscriber Number (DSN) as a key to identify all of the protocol level messages pertaining to a particular SMS. The INAP Handler Module 301 may interface with the System Kernel Module 303 over Inter-Process Communication (IPC). The IPC mechanism, for example, may be operating system queues, TCP/IP socket, etcetera.

The Mobile Application Part (MAP) Handler Module 302 may send and receive all of the MAP protocol messages related to the proposed system 399. The MAP Handler Module 302 may be used to encode and decode the required MAP messages in the specified format (vide specification numbers ETSI ETS 300 599 or 3GPP TS 09.02 v4.17.1 for MAP phase 2, ETSI TS 129 0002 v6.8.0 or 3GPP TS 29.002 v6.8.0, ETSI ETS 300 974 or 3GPP TS 09.02 v7.9.0 for MAP phase 2+, ETSI GSM 3.04 or 3GPP TS 23.040 for SMS Technical Realization). The MAP Handler Module 302 may store the CPM and DSN to identify all of the protocol level messages pertaining to a particular SMS. The INAP Handler Module 301 may interface with the System Kernel Module 303 over IPC. The IPC mechanism, for example, may be operating system queues, TCP/IP socket, etcetera.

The System Kernel Module 303 may maintain the state transitions between various functional entities pertaining to a particular SMS. The System Kernel Module 303 may receive data from the INAP Handler Module 301, the MAP Handler Module 302, and the Content Selection Module 304 in pre-defined structure. The System Kernel Module 303 may also perform required business logic depending upon the current state, and may send responses to the required modules accordingly. The INAP Handling Module 301 interfaces with all other modules over IPC. The IPC mechanism, for example, may be operating system queues, TCP/IP socket, etcetera.

The Content Selection Module 304 may select appropriate content based upon the SMS as per pre-defined rules; for example, total count of content to be appended, content based on date/time, location of the recipient of the SMS, etcetera. The Content Selection Module 304 may receive a request from the System Kernel Module 303 for content. The Content Selection Module 304 may select content from various resources, for example, storage in internal memory pool, the Database 311, or the Content Provider (CP) 308. Once the content is fetched, the response containing the content for every trigger received may be sent back to the System Kernel Module 303.

The Config & Admin Module 305 may act as a graphical user interface for configuration/management of contents and various operational and maintenance (O&M) activities of the proposed system 399.

The MIS & Reports Module 306 may generate various management information system (MIS) and usage reports, as required.

The Web Server Module 307 may act as the relay layer between external interfaces and system modules 305/306.

The Database 311 may act as a repository and storage for data required for the functionality of the proposed system 399.

External Entities 398 may be a group of entities connected to the proposed system 399 over HTTP; such as CP 308 for providing requisite content; Customer Care 309 of the carrier/operator where the proposed system 399 is deployed for viewing reports, resolving complaints, etcetera; and System Administration 310 for operational and maintenance activities.

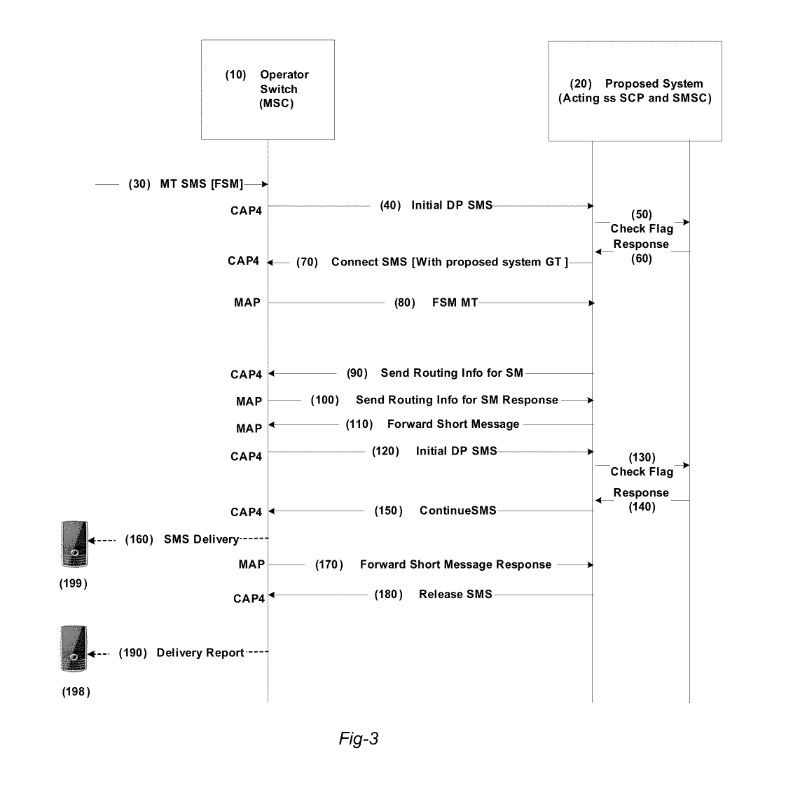

Referring now to FIG. 3, MT (Mobile Terminated) SMS 30 may be the FSM (forward short message) received by the O-MSC 10. The MT SMS 30 may contain the actual data to be delivered to the recipient MS. Upon receipt of this trigger, the O-MSC 10 may check the configuration flag for each mobile subscriber (MS) profile [For Ericsson switches, the flag is named as OICK; other switch vendors may have different names for the flag] in the HLR. Based upon OICK key value, the O-MSC 10 may send the INAP Initial DP (Detection Point) SMS trigger 40 to the proposed system 20 for next action.

Initial DP SMS 40 may be received by the proposed system 20. The initial DP SMS 40 may be decoded as per the specifications identified in paragraph [0008]. Upon receipt of the Initial DP SMS trigger 40, the proposed system 20 may use Check Flag 50 for the particular DSN-CPN key (for example, value 0 may mean not set and value 1 may mean set) to decide the next action. The Response 60 may be received with value as 0, hence, INAP Connect SMS 70 may be sent back to the O-MSC 10. The flag value may be set to 1 for the particular DSN-CPN key. When the Initial DP SMS 120 is received for the second time, the value of the flag may be 1 for that particular DSN-DPN key, hence INAP Continue SMS 150 may be sent back to the O-MSC 10, the flag may be reset to 0.

Connect SMS 70 may be encoded for the particular DSN-CPN key as per the specifications identified in paragraph [0008] and may be sent to the O-MSC 10 with the proposed system's 20 Global Title (GT) address. As a result, the O-MSC 10 may forward the received FSM 30 to the proposed system 20, shown as FSM MT 80. The received FSM 30 may be decoded as per the specifications identified in paragraph [0009].

FSM MT 80 may be forwarded to the proposed system 20 over SS7 MAP protocol. The parameters may be decoded according to the specifications identified in paragraph [0009]. The SMS-related parameters, for example Origination Address (OA), Destination Address (DA), and User Information may be processed to select the proper content required to be appended to the original message. The proposed system 20 now may act as SMSC and may perform the required functions to deliver a SMS such as encoding and sending SRI (send routing info) for Short Message (SM) 90, decoding the SRI for SM Response 100, encoding and sending FSM 110−the SMS data now may contain the original message data+the content. Once the proposed system 20 sends FSM 110, the O-MSC 10 may again receive the MT SMS 30 and send the second Initial DP SMS 120 back to the proposed system 20. Check Flag 130 may result in Response 140, with flag value 1, hence Continue SMS 150 may be sent to the O-MSC 10.

Upon receipt of Continue SMS 150, the O-MSC 10 may deliver the SMS, SMS Delivery 150 to the MS 199 and send back the FSM Response 170. The proposed system 20 may send back the Release SMS 180 with delivery status code for the Initial DP SMS 40. The O-MSC 10 may, in turn, send the Delivery Report 190 to the SMS initiator mobile user 198.

It should be understood, of course, that the foregoing relates to exemplary embodiments of the invention and that modifications may be made without departing from the spirit and scope of the invention as set forth in the following claim.

What is claimed is:

1. A process for inserting content into short message service messages at the delivery end of global system for mobile communication networks, comprising:
an operator switch receiving a first forward short message from a short message service initiator mobile user;
said operator switch checking configuration flags of mobile subscriber profiles;
said operator switch sending a first initial detection point short message system trigger to said system for next action;
said system receiving said first initial detection point short message system trigger;
said system receiving decoding said first initial detection point short message system trigger and deciding next action;
said system encoding a connect short message service trigger;
said system sending said connect short message service trigger to said operator switch;
said operator switch forwarding said first forward short message to said proposed system;
said proposed system decoding said first forward short message;
said proposed system creating a second forward short message by inserting said content into the original message data of said first forward short message;
said proposed system sending said second forward short message to said operator switch;
said operator switch receiving said second forward short message;
said operator switch sending a second initial detection point short message service trigger to said proposed system for next action;
said proposed system sending a continue short message service trigger to said operator switch;
said operator switch receiving said continue short message service trigger;
said operator switch delivering said second forward short message to a mobile subscriber;
said operator switch sending a forward short message response to said proposed system;
said proposed system sending a release short message service trigger with delivery status code to said operator switch; and
said operator switch sending a delivery report to said short message service initiator mobile user.
